(19) United States
(12) Patent Application Publication
(10) Pub. No.: US 2007/0226707 A1
(43) Pub. Date: Sep. 27, 2007

(54) Transforming product description information

(76) Inventors: Nardo B. Catahan JR., South San Francisco, CA (US); Richard Mark Exley, San Carlos, CA (US); Shailendra Garg, Sunnyvale, CA (US); Annaji Rao Garimella, Cupertino, CA (US); Shekhar P. Kale, Foster City, CA (US); Maria Theresa Barnes Leon, Fremont, CA (US); Srinivas Rajagopalan, San Jose, CA (US); Roland Pierre Vallet, San Francisco, CA (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 10/329,303

(22) Filed: Dec. 23, 2002

Related U.S. Application Data
(60) Provisional application No. 60/422,918, filed on Nov. 1, 2002.

(51) Int. Cl. G06F 9/45

(52) U.S. Cl. 717/136

(57) ABSTRACT

A facility for displaying a product definition is described. The facility retrieves a body of product information in a first form that is compatible with a first software package. The facility transforms the product information in the first form into product information in a second form that is distinct from the first form. The facility then transforms the product information in the second form into product information in a third form that is compatible with the second software package and distinct from the first and second forms. Using the product information in the third form, the facility generates a product display using the second software package.

### CROSS REFERENCE TO RELATED APPLICATIONS

This application claims the benefit of U.S. Provisional Patent Application No. 60/422,918 filed Nov. 1, 2002, entitled, “TRANSFORMING PRODUCT DESCRIPTION INFORMATION,” which is hereby incorporated by reference in its entirety.

### TECHNICAL FIELD

The present invention is directed to the field of business data transformation.

### BACKGROUND

It is common for product manufacturers and suppliers to use back-end software packages to provide support for such functions as product design, manufacturing, assembly, and warehousing. Many such back-end functions relate to the definition and possible configuration of products manufactured and/or supplied by users of such back-end software packages.

In order to take advantage of such back-end software packages, their users typically must store product data in forms usable by the back-end software packages. In some cases, product definition and configuration data is stored in a form in which classes of products are defined, then used to define individual products within these classes.

Also available are front-end software packages, which provide support to product retailers and marketers for such functions as product marketing, on-line sales, and information resources for sales forces. In order to take advantage of such front-end software packages, their users typically must store product data in forms usable by the front-end software packages, which often differ significantly from the forms usable with back-end software packages.

Generally, in order to use a front-end software package for products for which a back-end software package is already being used, the user must manually regenerate the product data in forms usable by the front-end software package. Such manual regeneration has several significant disadvantages, including: (1) it is often expensive; (2) it often requires a substantial amount of time to complete; (3) it must be repeated each time product data changes in the back-end system; and (4) it is prone to errors.

In view of the foregoing, an automated approach to transforming product data used by a back-end software package for use by a front-end software package would have significant utility.

### BRIEF DESCRIPTION OF THE DRAWINGS

FIG. 1 is a network diagram showing aspects of a typical hardware environment in which the facility operates.

FIG. 2 is a block diagram showing some of the components typically incorporated in at least some of the computer systems and other devices on which the facility executes.

FIG. 3 is a flow diagram showing steps typically performed by the facility in order to transform product information from the first source format to the target format.

FIGS. 4A-4C are data structure diagrams showing sample intermediate data structure contents produced from the class definitions in the first source format shown in Table 1.

FIG. 5A-5B are data structure diagrams showing sample message structures in the target format created by the facility from the intermediate data structure shown in FIGS. 4A-4C.

FIG. 6 is a data structure diagram showing a sample configurable material definition in the first source format to be transformed.

FIG. 7 is a data structure diagram showing the transformation of the configurable material definition shown in FIG. 6 into an intermediate data structure.

FIG. 8 is a data structure diagram showing the transformation of the intermediate data structure shown in FIG. 7 into configurable product in the target format.

FIG. 9 is a flow diagram showing steps typically performed by the facility in order to transform product information from the second source format to the target format.

FIG. 10 is a data structure diagram showing a sample configurable Bill of Material (BOM) definition in the second source format to be transformed.

FIGS. 11A-11B are data structure diagrams showing the transformation of the configurable BOM definition shown in FIG. 10 into an intermediate data structure.

FIG. 12 is a data structure diagram showing the transformation of the intermediate data structure shown in FIGS. 11A-11B into a configurable product in the target format.

### DETAILED DESCRIPTION

A software facility (hereafter “the facility”) for automatically transforming product definition and configuration information (hereafter “product information”), such as one or more configurable product definitions, is described. In some embodiments, the facility transforms product information from a form used by a source system to a form used by a target system. In some embodiments, source systems may be back-end systems providing support for such functions as product design, manufacturing, assembly, and warehousing. In some embodiments, target systems may be front-end system providing support for such functions as product marketing and sales, such as Siebel Sales and Siebel Call Center and other similar software packages (hereafter “Siebel”).

In some embodiments, such as embodiments adapted to transforming product information in the first source format, the facility transforms product information in a sequence of three phases to construct a configurable product in the target format, by first transmitting product class information, then product class membership information, and then product detail information. In some embodiments, such as embodiments adapted to transforming product information in a second source format, the facility transforms product information in a single phase by constructing a network of related configurable products in Siebel corresponding to the configurable Bill of Material (BOM) in the second source format and each option list referenced in the configurable BOM. In some embodiments, the facility generates and uses an intermediate representation of some or all of the product information it transforms. In some embodiments, the facility uses specialized logic to transform product information between source and target formats (and any intermediate format) that is tailored to particular aspects of these formats.

By performing such transformations, embodiments of the facility enable a user of a first system who has stored product information in a first format for use by the first system to readily make the stored product information available for use in a second system that utilizes a second format in a cost-efficient and time-efficient manner.

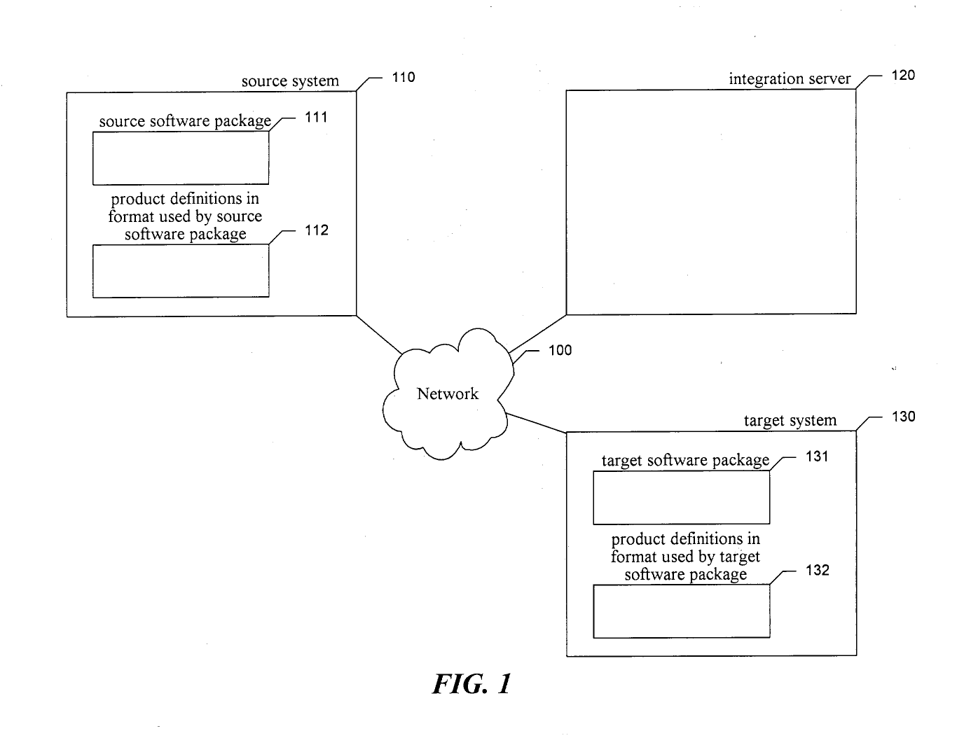

FIG. 1 is a network diagram showing aspects of a typical hardware environment in which the facility operates. FIG. 1 shows a source system 110 on which resides a source software package 111 and product definitions 112 that are in a format used by the source software package. FIG. 1 further shows a target system 130 on which resides a target software package 131 and product definitions 132 that are in a format used by the target software package. For example, target software package 131 may be Siebel Sales, and if so then product definitions 132 may be stored in the format used by Siebel Sales. The facility (not shown) performs transformations on some or all of the product definitions 112 in the format used by the source software package to convert them into product definitions 132 in the format used by the target software package. Such transformation may involve one or more other computer systems, such as an integration server system 120. Components of the facility may reside on and/or execute on any combination of these computer systems, and intermediate results from the transformation may similarly reside on any combination of these computer systems.

The computer systems shown in FIG. 1 are connected via a network 100, which may use a variety of different networking technologies, including wired, guided or line-of-sight optical, and radio frequency networking. In some embodiments, the network includes the public switched telephone network. Network connections established via the network may be fully-persistent, session-based, or intermittent, such as packet-based. While the facility typically operates in an environment such as is shown in FIG. 1 and described above, those skilled in the art will appreciate the facility may also operate in a wide variety of other environments.

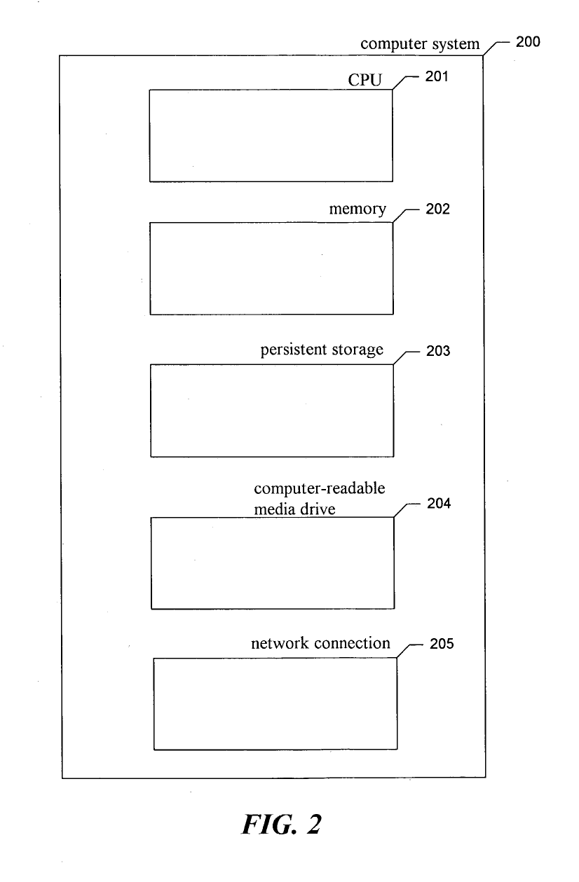

FIG. 2 is a block diagram showing some of the components typically incorporated in at least some of the computer systems and other devices on which the facility executes, including some or all of the server and client computer systems shown in FIG. 1. These computer systems and devices 200 may include one or more central processing units (“CPUs”) 201 for executing computer programs; a computer memory 202 for storing programs and data—including data structures—while they are being used; a persistent storage device 203, such as a hard drive, for persistently storing programs and data; a computer-readable media drive 204, such as a CD-ROM drive, for reading programs and data stored on a computer-readable medium; and a network connection 205 for connecting the computer system to other computer systems, such as via the Internet, to exchange programs and/or data—including data structures. While computer systems configured as described above are typically used to support the operation of the facility, those skilled in the art will appreciate that the facility may be implemented using devices of various types and configurations, and having various components.

It will be understood by those skilled in the art that the facility may transform product information from a number of different source systems and from a number of different source software packages to a number of target systems and/or to a number of target software packages.

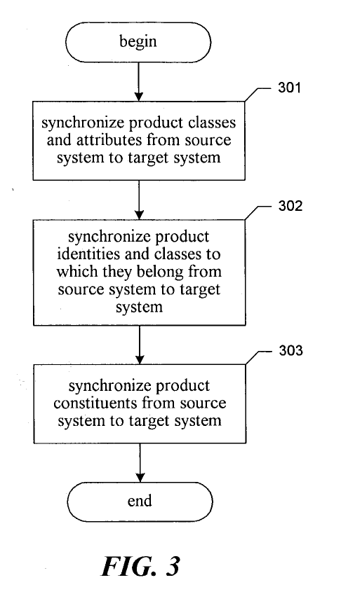

FIG. 3 is a flow diagram showing steps typically performed by the facility in order to transform product information from the first source format to the target format. In step 301, the facility synchronizes product classes and attributes from the source system to the target system. In some embodiments, step 301 involves obtaining a Class IDOC message from the source system. In step 302, the facility synchronizes product identities, and the classes to which products belong, from the source system to the target system. In some embodiments, step 302 involves obtaining a Characteristics IDOC message from the source system. In step 303, the facility synchronizes product constituents from the source system to the target system. In some embodiments, step 303 involves obtaining a Classification IDOC message from the source system. After step 303, these steps conclude.

The steps shown in FIG. 3 may be repeated periodically, either to re-transform all of the product information in the source system, to transform product information that is changed in the source system since the last transformation, and/or to transform one or more particularly selected product classes or products. The facility may perform transformations from various source systems on which is executing various source software packages, and/or transform product information to various target systems executing different target software packages.

To further illustrate the process shown in FIG. 3, an example of such a transformation is discussed below. Table 1 below shows a set of product classes relating to the configurable product in the first source format to be transformed to Siebel format in this example.

TABLE 1

| | Class | | | | List of |
|---|---|---|---|---|---|
| Class | Type | Parent | Attribute Name | Range | Values |
| Color | 300 | | Exterior Color | | Blue, Black, |
| | | | | | Green |
| Computer | 300 | Color | Exterior Color | | Blue, Black, |
| | | | (Inherited) | | Green |
| | | | Memory (MB) | 64 to 1024 | |
| | | | Storage Capacity | | 10, 20, 30, |
| | | | (GB) | | 40 |
| | | | Frequency (Hz) | | 60, 65, 70 |
| Case | 300 | | Size | | Small, |
| | | | | | Medium, |
| | | | | | Large |
| Hard | 200 | | Storage Capacity | | 10, 20, 30, |
| Drive | | | (GB) | | 40 |
| Monitor | 200 | | Frequency (Hz) | | 60, 65, 70 |
| RAM | 200 | | Memory (MB) | 64 to 1024 | |
| Paint | 200 | | Exterior Color | | Blue, Black, |
| | | | | | Green |
| Case | 200 | | Size | | Small, |
| | | | | | Medium, |
| | | | | | Large |

These product classes include a Computer class, of which a configurable product to be transformed to Siebel format is a member. In this example, the Computer class specifies a number of configurable attributes for the products that are members of the class, including Memory, Storage Capacity, and Frequency attributes. The Computer class is also a subclass of a Color class, and therefore inherits the Exterior Color attribute of the Color class. As illustrated in Table 1, each attribute has either an associated range or list of values it can take on. For example, the Memory attribute in this example can take on values in the range between 64 and 1024 (with the associated measurement unit being megabytes, or “MB”), while the Storage Capacity attribute in this example may take on any of the values 10, 20, 30, and 40. Table 1 also shows the class type of each class, with class type 300 indicating Variant classes (whose members must be configured before they are used in the illustrated embodiment) and class type 200 indicating classes in the illustrated embodiment whose attributes are fixed rather than configurable.

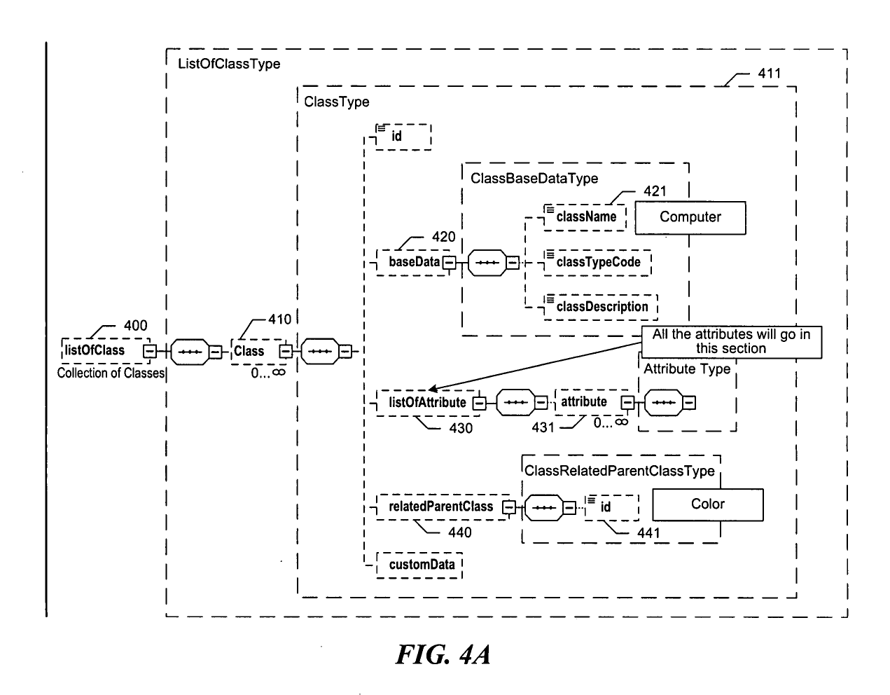

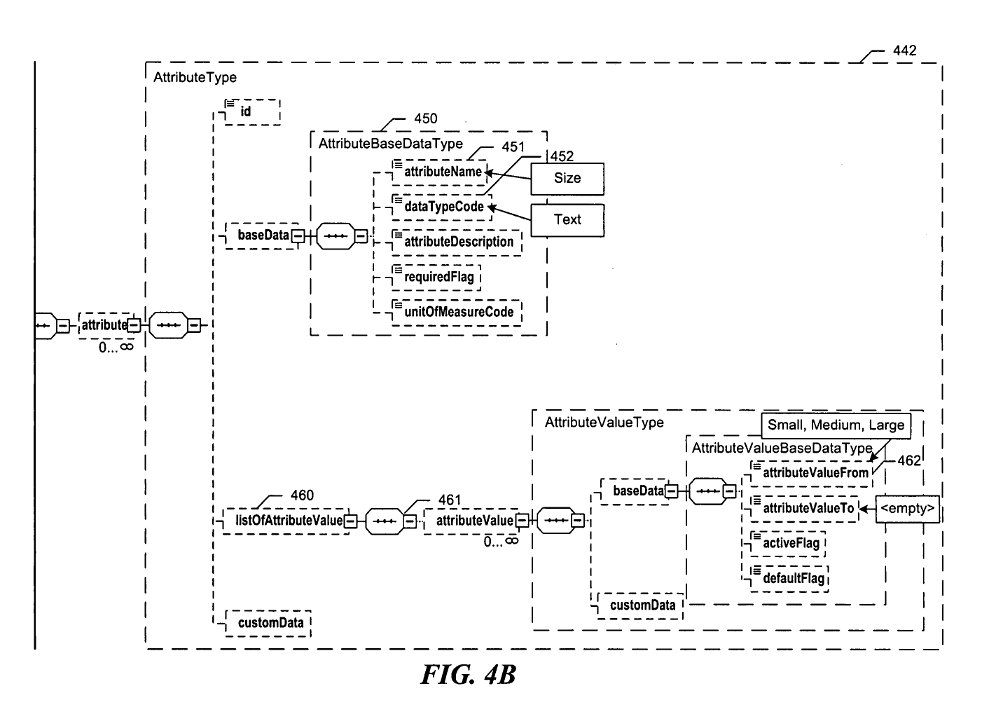

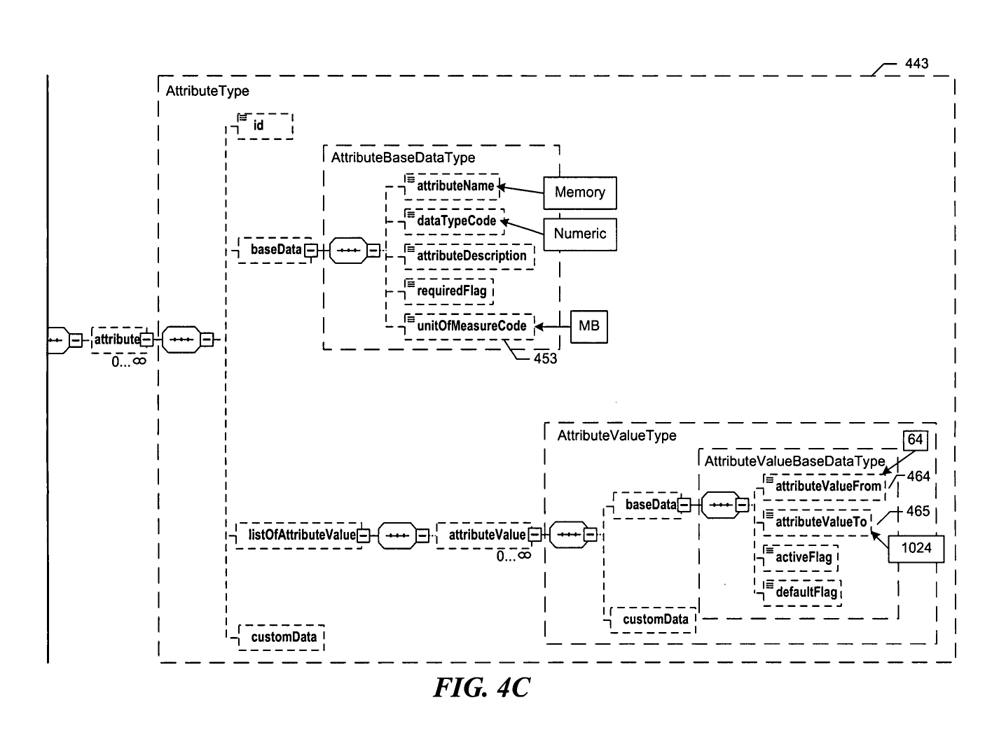

FIGS. 4A-4C are data structure diagrams showing sample intermediate data structure contents produced from the class definitions in the first source format shown in Table 1. In particular, the illustrated intermediate data structure 400 is of type listOfClass, which may contain any number of Class data structures 410. One such illustrated Class data structure 411 includes a baseData section 420, a listOfAttribute section 430, and a relatedParentClass section 440, and may also include various other information such as various custom data. The baseData section includes identifying information about the class that is obtained from the class in the first source format, including className 421 Computer. The listOfAttribute section contains any number of attributes 431 of the class, with various examples shown in FIGS. 4B and 4C and discussed in greater detail below. The relatedParentClass section 440 contains the identifier 441 of the class that is the parent of the Computer class, which in this example is the Color class.

FIGS. 4B and 4C show examples of attributes 431 occurring in the listOfAttribute section 430. In particular, FIG. 4B shows a Size attribute 442 of the Computer class. The Size attribute includes a baseData section 450, which contains information identifying the attribute and its type, and a listOfAttributeValue section 460, which in turn includes one or more attributeValue sections 461. As is shown, the baseData section 450 includes an attributeName field 451 containing the attributeName “Size” and a dataTypeCode field 452 containing the data type “Text”. In the illustrated embodiment, only one attributeValue section is present, and that attributeValue section 463 includes an attributeValueFrom field 462 containing the list of permissible values for the Size attribute, those being “Small”, “Medium”, and “Large”.

FIG. 4C shows another example attribute, that being the Memory attribute 443 of the Computer class. While FIG. 4C is similar to FIG. 4B, it can be seen that in FIG. 4C a unitOfMeasureCode field 453 is present to indicate a unit of measure for the memory attribute, which in this case is “MB”. It can also be seen that, because the possible values of the Memory attribute are specified as a range, both the attributeValueFrom field 464 and the attributeValueTo field 465 contain values in this example.

From intermediate data structures such as those shown in FIGS. 4A-4C, the facility creates a number of data structures in the target format by transforming the classes into the target format. In particular, for each attribute of each class, the facility can create a class-attribute message structure corresponding to that attribute. For a range attribute, a corresponding class-attribute message contains all of the information about the possible values for that attribute. For an enumerated attribute, a corresponding class-attribute message refers to a “list of values” message structure, which in turn refers to a number of “list of values child” message structures, each of which corresponds to a single possible value of the enumerated attribute.

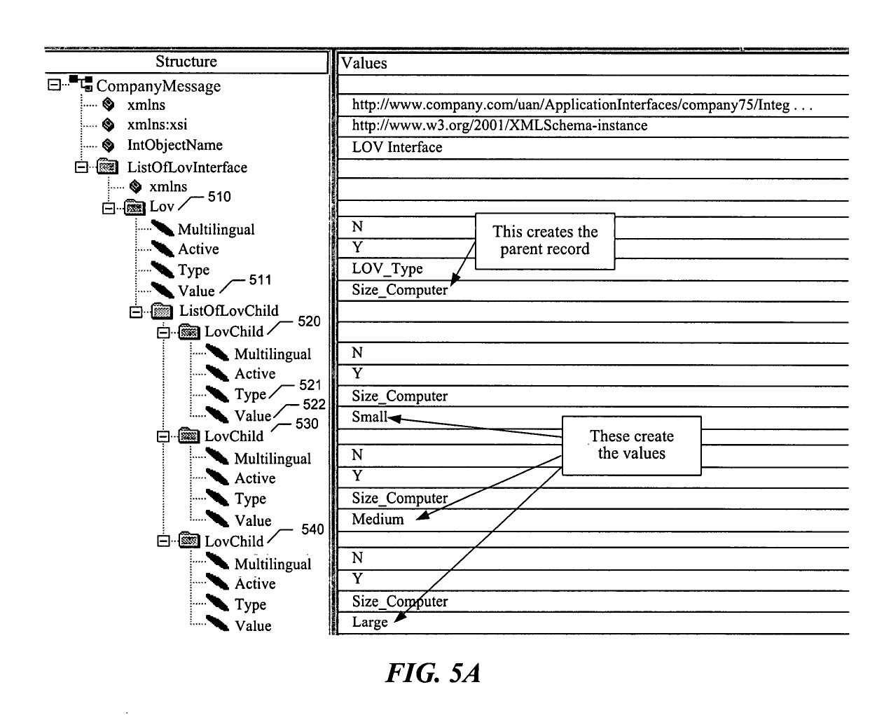

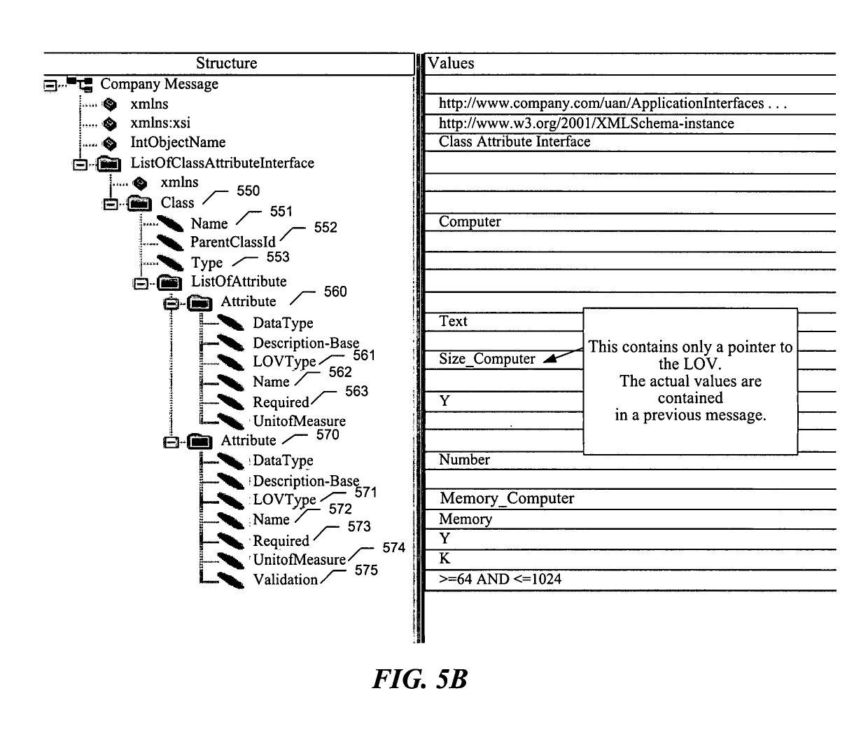

FIGS. 5A-5B are data structure diagrams showing sample list of values message structures created in the target format by the facility from the intermediate data structure shown in FIGS. 4A-4C. In particular, FIG. 5A shows a list of value and list of value child message structures created by the facility. It can be seen that a list of value (or “Lov”) message structure 510 has been created to correspond to the Size attribute, and that it contains a value 511 that relates to each of the list of value child (or “LovChild”) message structures 520, 530, and 540. Each of these list of value child message structures contains one of the possible values for the Size attribute. For example, list of value child message structure 520 contains the possible value “Small” for the Size attribute.

FIG. 5B shows a sample class-attribute message structure 550 for the Computer class. This message structure includes the name 551 of the class, a field 552 for including the class ID of the parent class for the class, and a class type field 553. The message structure further includes attributes, including attributes 560 and 570. Attribute 560 corresponds to the Size attribute, and contains a list of value type 561 (with a value of “Size_Computer”) as described in FIG. 5A, an attribute name 562, and an indication 563 of whether the attribute is required. Attribute 570 corresponds to the enumerated attribute Memory, and further contains a unit of measure 574 and a validation range 575 of permissible values for this attribute. Other attributes of the Computer class will be reflected in the class-attribute message structure in a similar manner.

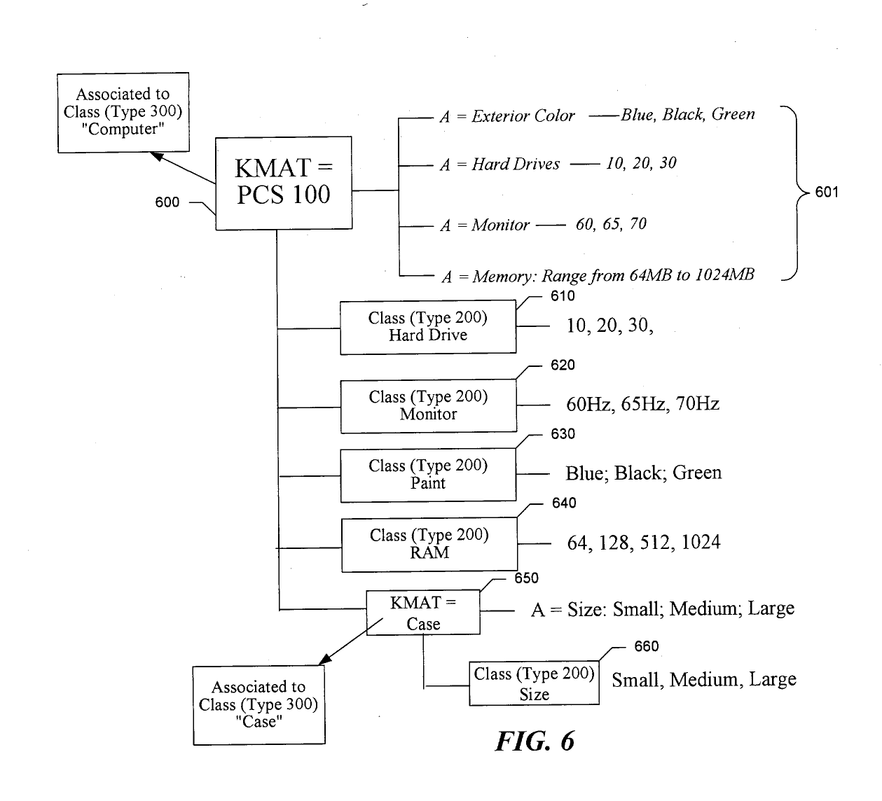

FIG. 6 is a data structure diagram showing a sample configurable product definition in the first source format to be transformed. The configurable product here is a computer system model named PCS 100, which is defined in the first source format as a configurable material, or KMAT. The configurable material has a number of attributes 601, and an associated bill of material which has a number of classes 610-640 corresponding to those attributes. This bill of material also has an associated configurable material or KMAT 650, which is a computer case that is shipped with the PCS 100 product. Configurable material 600 for the PCS 100 product is associated with the Computer class, while configurable material 650 for the case product is associated with the Case class.

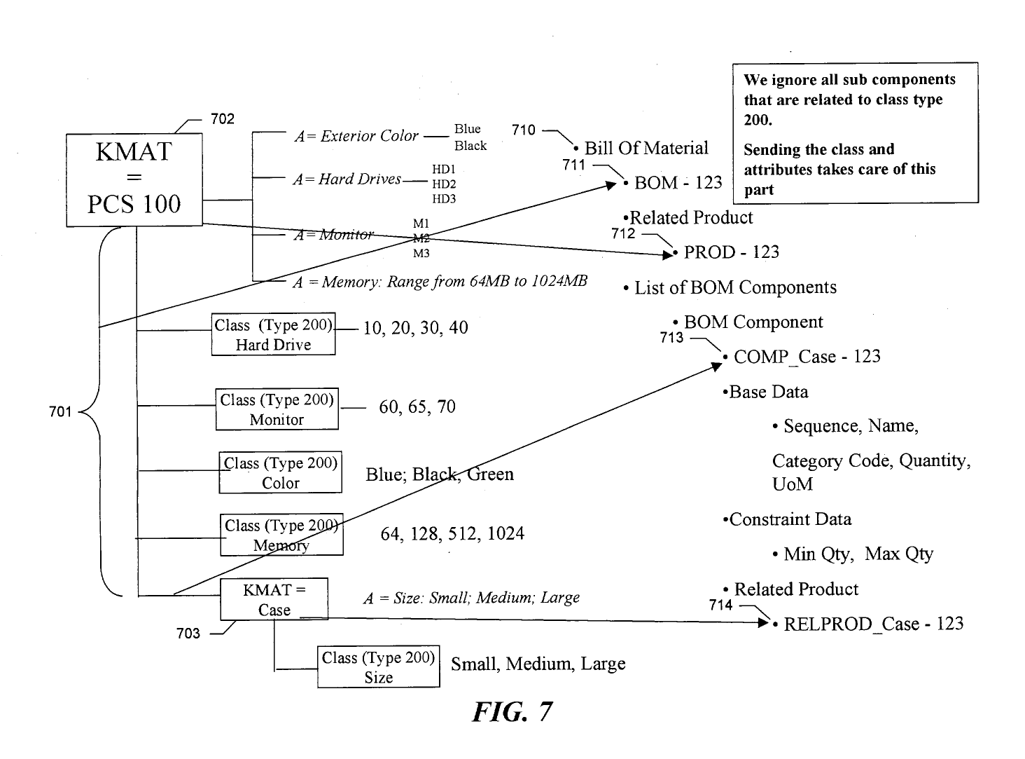

FIG. 7 is a data structure diagram showing the transformation of the configurable product definition shown in FIG. 6 into an intermediate data structure. It can be seen that a bill of materials (or “bom”) structure 710 is created, which contains a bill of materials based upon the bill of material that is associated to the configurable material 702. The bill of material further contains a related product ID 712 taken from the PCS 100 product, a bill of materials component ID 713 taken from the associated case configurable material, and a related product ID 714 taken from the associated case configurable material 703. In the illustrated embodiment, the bill of materials does not contain any information from the type 200 classes whose contents can be derived from the Computer class to which the configurable product belongs, which was earlier transformed to Siebel format.

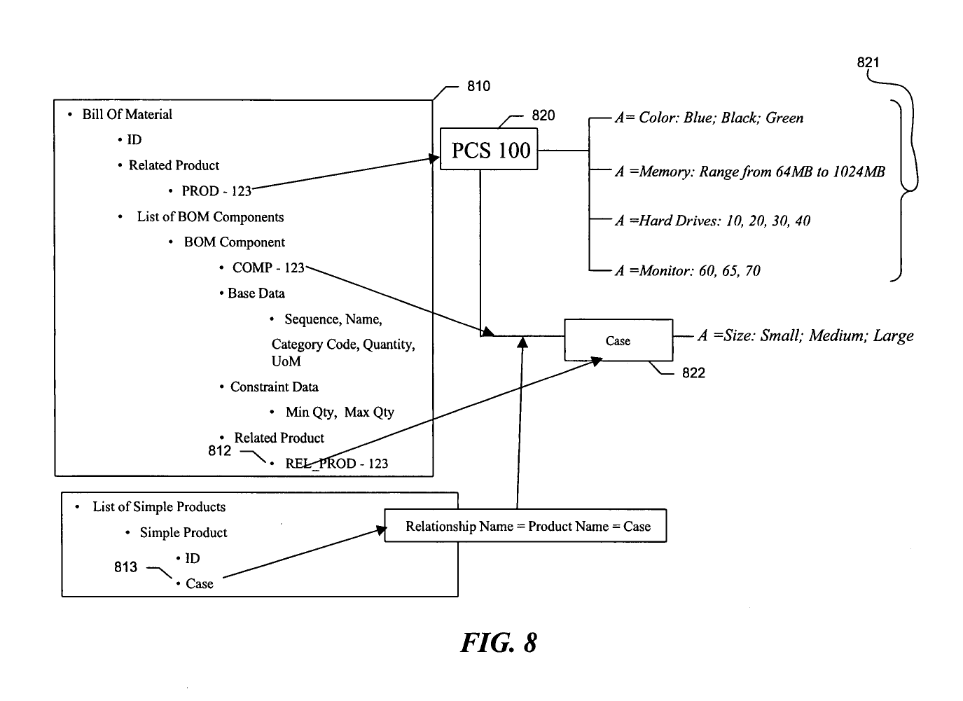

FIG. 8 is a data structure diagram showing the transformation of the intermediate data structure shown in FIG. 8 into a configurable product in the target format. In particular, the facility creates Siebel configurable product 820 to correspond to the PCS 100 product, with the configurable product 820 including attributes 821 because it is of class Computer. Based upon the inclusion of related products specification 812 in the bill of materials, the facility also establishes a relationship between the configurable product 820 and a case product 822 earlier created in the target format by the facility as a simple product 813.

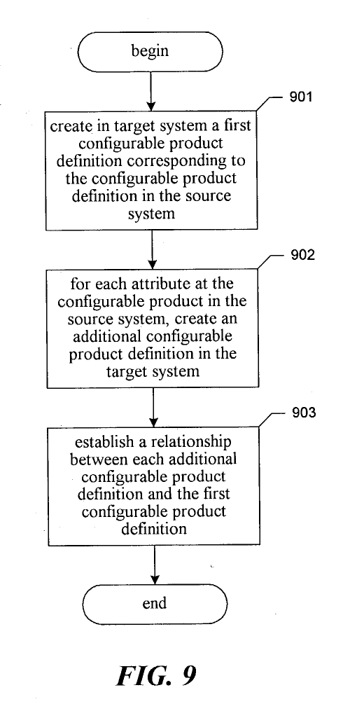

FIG. 9 is a flow diagram showing steps typically performed by the facility in order to transform product information from the second source format to the target format. These steps are typically repeated once for each configurable product definition that is to be transformed. In step 901, the facility creates in the target system a first configurable product definition corresponding to the configurable product definition in the source system. In step 902, for each attribute of the configurable product in the source system, the facility creates an additional configurable product definition in the target system that corresponds to the attribute in the source system. In step 903, the facility establishes a relationship between each of the additional configurable product definitions created in step 902 and the first configurable product definition created in step 901. After step 903, the steps conclude.

To further illustrate the process shown in FIG. 9, an example of such a transformation is discussed below.

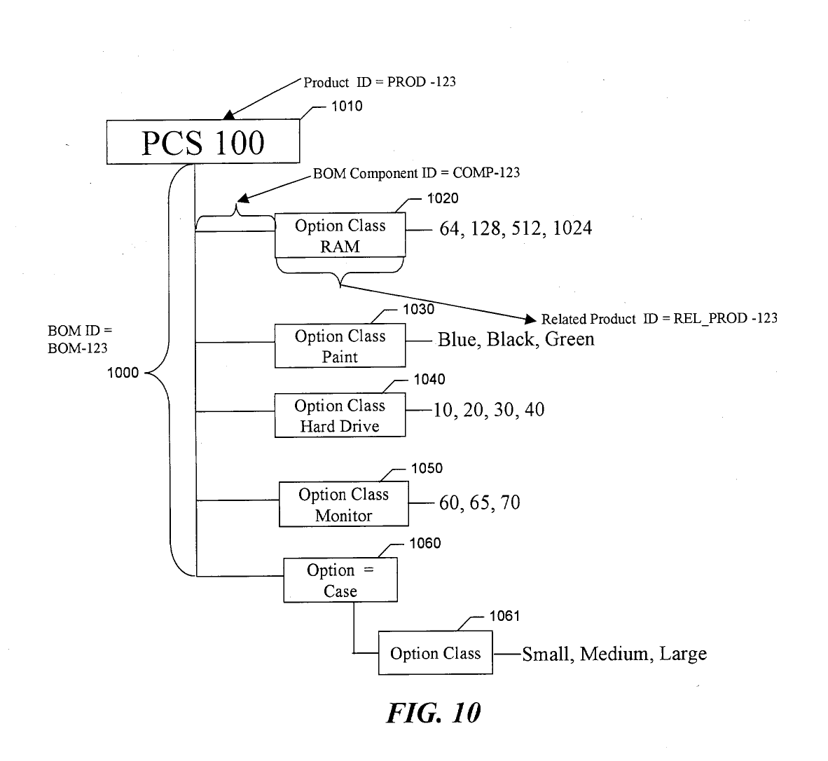

In particular, FIG. 10 illustrates a data structure diagram showing a sample configurable BOM definition in the second source format to be transformed. The sample configurable bill of material is item 1010 corresponding to the PCS 100 product, which owns the bill of material 1000. The item includes option classes 1020, 1030, 1040 and 1050, each of which is a grouping of different options as shown to the right of each option class. For example, option class 1020 corresponds to an amount of RAM for the computer, with the options being values of 64, 128, 512 and 1024. The item also includes a Case option 1060 that in turn refers to its own option class 1061.

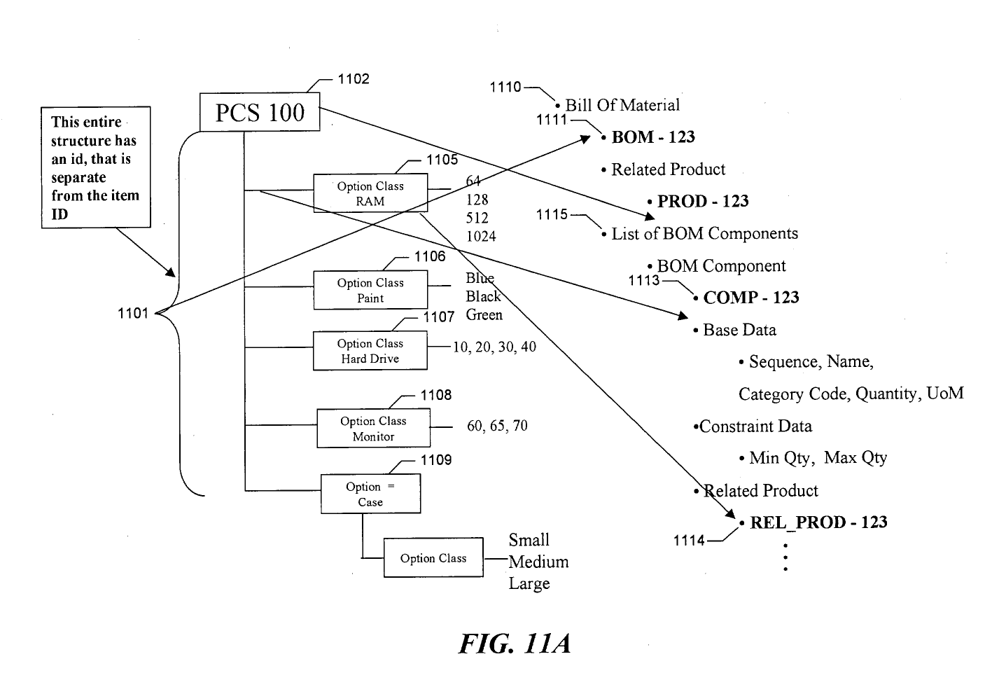

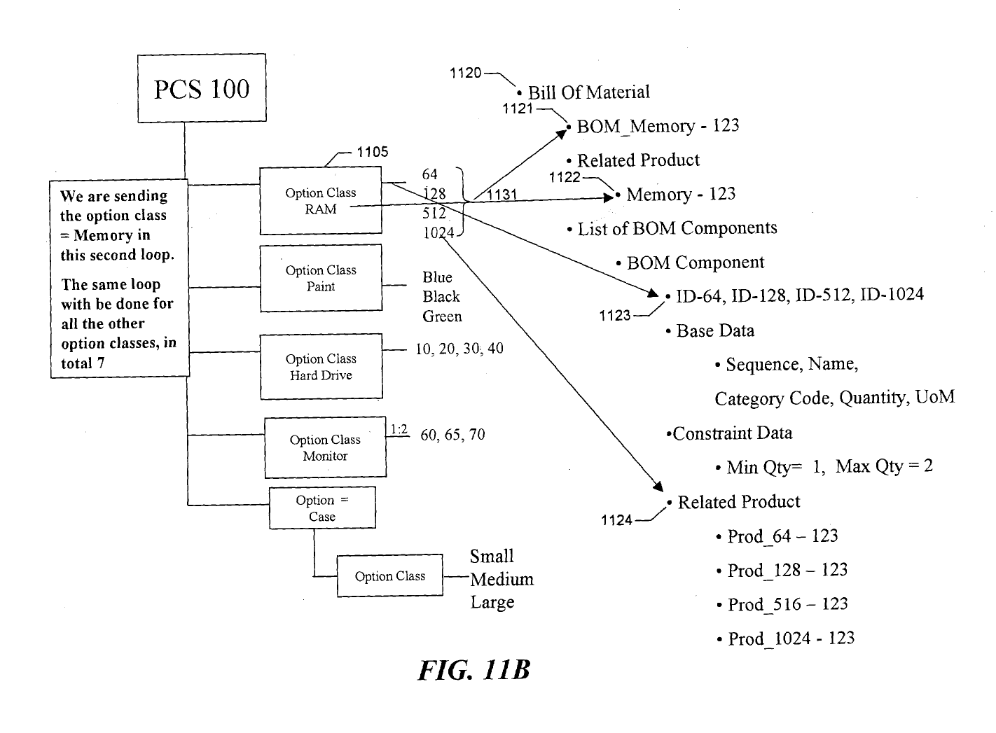

FIGS. 11A-11B are data structure diagrams showing the transformation of the configurable BOM definition shown in FIG. 10 into a BOM intermediate data structure. The configurable BOM definition is transformed into a bill of material intermediate data structure 1110. The bill of materials includes a bill of materials ID 1111 (taken from the bill of materials in the second source format), a related product ID (taken from item 1102), a bill of material component ID 1113 (taken from the component ID used to make option class 1105 a component of item 1102), and a related product ID 1114 (taken from the RAM option class 1105). Bill of material 1110, and in particular a list of BOM components 1115, includes additional information about other components 1106-1109 of the item 1102. Further, the facility generates additional bill of materials for each of these components and/or subcomponents in turn.

FIG. 11B shows a bill of material 1120 for the RAM option class 1105. This bill of material includes a bill of material ID 1121 (taken from the RAM option class 1105), a related product ID 1122 (taken from the RAM option class 1105), a bill of material component ID list 1123 (taken from the options 1131 that make up the RAM option class 1105), and related product IDs 1124 (taken from the options 1131 of option class 1105).

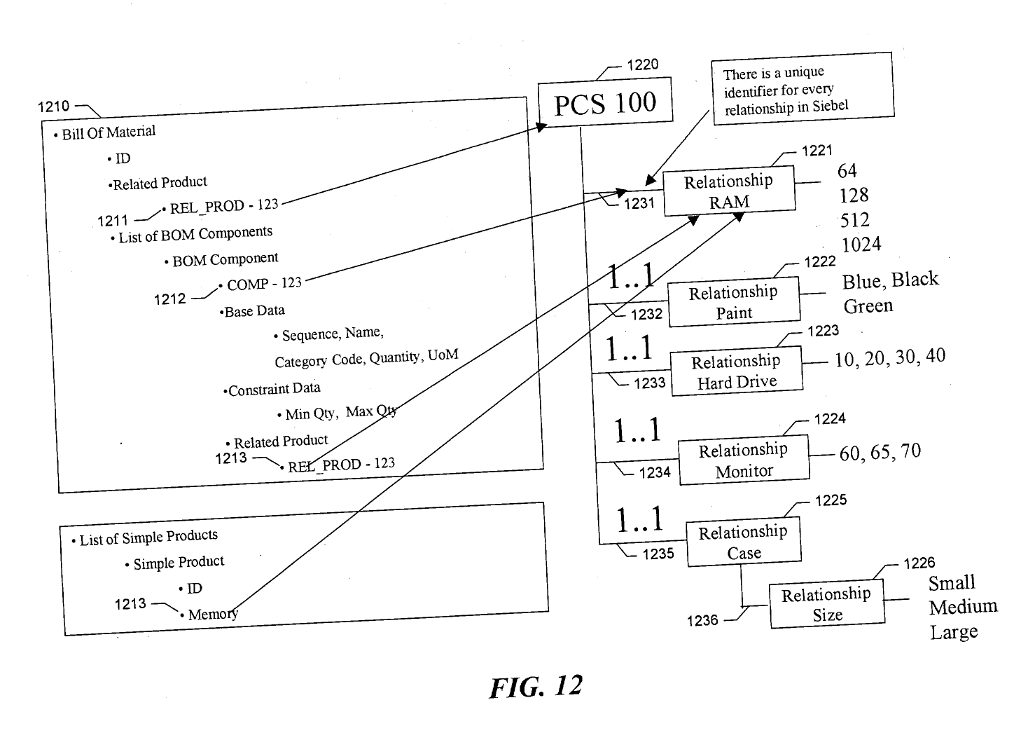

FIG. 12 is a data structure diagram showing the transformation of the intermediate data structure shown in FIGS. 11A-11B into a configurable product in the target format. In particular, a configurable product 1220 is created in the target format from the bill of materials 1210, as previously discussed in conjunction with FIGS. 11A-11B. The configurable product 1220 is made up of a number of relationships 1221-1226 with other products that each correspond to one of the components of the item in the second source format. The relationships are each associated with their corresponding configurable product by associations 1231-1236. For example, the configurable product 1220 is created from related product ID specification 1211 in the bill of materials. The association 1231 with the relationship 1221 to the RAM product is created based upon the bill of materials component ID specification 1212 in the bill of materials 1210, as well as the related product ID specification 1213 in the bill of materials. The relationship 1221 with the RAM product establishes the relationship with a memory simple product 1213 created earlier by the facility.

It will be appreciated by those skilled in the art that the above-described facility may be straightforwardly adapted or extended in various ways. For example, the facility may be used to transform various other kinds of product information, and may be used to transform product information between a variety of other formats. While the foregoing description makes reference to preferred embodiments, the scope of the invention is defined solely by the claims that follow and the elements recited therein.

1. A computer-implemented method for displaying a product definition, comprising:
retrieving a body of a first product information in a first form, wherein the first form is compatible with a first software package;
transforming the first product information in the first form into first product information in a second form, wherein the second form is distinct from the first form;
transforming the first product information in the second form into first product information in a third form, wherein the third form is compatible with a second software package and distinct from the first and second forms; and
using the first product information in the third form to generate a product display using the second software package.

2. The method of claim 1, further comprising:
retrieving a body of second product information in a fourth form, wherein the fourth form is compatible with a third software package and distinct from the first, second, and third forms;
transforming the second product information in the fourth form into second product information in the second form;
transforming the second product information in the second form into second product information in the third form; and
using the second product information in the third form to generate a product display using the second software package.

3. A method in a computing system for transforming product information for each of a plurality of products from a first format to a second format, comprising:
(a) transforming from the first format to an intermediate format product classifications and attributes associated with the product classifications, each of the transformed format product classifications having as a member at least one of the plurality of products;
(b) after (a), transforming from the first format to the intermediate format, for each product among the plurality, the name of the product and the classification of which the product is a member, to create the product as an instance of the classification transformed in (a); and
(c) after (b), for each product among the plurality, transforming from the first format to the intermediate format individual characteristics of the product to customize the instance created in (b) in accordance with the individual characteristics of the product; and
(d) after (c), transforming from the intermediate format to the second format the product classifications and attributes associated with the product classifications.

4. A computer-readable medium comprising computer programs whose content cause a computing system to transform product information for each of a plurality of products from a first format to a second format by:
(a) transforming from the first format to an intermediate format product classifications and attributes associated with the product classifications, each of the transformed format product classifications having as a member at least one of the plurality of products;
(b) after (a), transforming from the first format to the intermediate format, for each product among the plurality, the name of the product and the classification of which the product is a member, to create the product as an instance of the classification transformed in (a); and
(c) after (b), for each product among the plurality, transforming from the first format to the intermediate format individual characteristics of the product to customize the instance created in (b) in accordance with the individual characteristics of the product; and
(d) after (c), transforming from the intermediate format to the second format the product classifications and attributes associated with the product classifications.

5. A method in a computing system for conveying a product definition class from a first system to a second system, comprising:
(a) retrieving identifying information for the class from the first system;
(b) retrieving information defining attributes of the class from the first system;
(c) for each attribute defined in the information retrieved in (b), creating in the second system a list of values containing the set of possible values for the attribute; and
(d) creating in the second system a class identified in accordance with the identifying information retrieved in (a), the created class containing attributes corresponding to the attributes defined in the information retrieved in (b), each attribute contained by the created class referencing one of the lists of values created in the second system in (c).

6. The method of claim 5 wherein (b) includes retrieving attribute information represented as a class in the first system, which (c) and (d) do not cause to be represented as a class in the second system.

7. The method of claim 5, further comprising:
(e) storing the identifying information retrieved in (a) in an intermediate data structure; and
(f) storing in the intermediate data structure the information defining attributes of the class and a set of possible values for each of the attributes retrieved in (b),
and wherein creating in (c) and (d) is performed using the information stored in the intermediate data structure.

8. The method of claim 5 wherein the intermediate data structure contains, for each attribute, a FROM field and a TO field, and wherein (f) involves:
for each attribute having a list of values, storing the list in the FROM field; and
for each attribute having a range of values, storing the bottom of the range in the FROM field and the top of the range in the TO field.

9. The method of claim 5, further comprising:
(e) retrieving identifying information for the class from a third system;
(f) retrieving information defining attributes of the class from the third system,
(g) for each attribute defined in the information retrieved in (f), creating in the second system a list of values containing the set of possible values for the attribute; and
(h) creating in the second system a class identified in accordance with the identifying information retrieved in (e), the created class containing attributes corresponding to the attributes defined in the information retrieved in (f), each attribute contained by the created class referencing one of the lists of values created in the second system in (g).

10. The method of claim 5, further comprising:
retrieving an indication a parent product class of which the class is a subclass; and
before (d), determining that identifying information for the parent product class and information defining attributes of the parent product class have already beet retrieved from the first system.

11. One or more computer memories collectively comprising:
a transformation intermediary data structure for transforming a plurality of product definition classes, the transformation intermediary data structure comprising, for each of the plurality of classes:
identifying information for the class; and
information fully defining the set of attributes attached to the class,
such that the data structure contains sufficient information to instantiate an instance of each of the plurality of classes.

12. The computer memories of claim 11, wherein the data structure was produced from product definition data in a first format, and wherein the product definition data in the first format contains both fixed materials classes and variant materials classes, and wherein the data structure contains variant materials classes but not fixed materials classes.

13. A method in a computing system for transforming definitions of configurable products, comprising:
receiving information identifying a product;
receiving information identifying a product class to which the identified product belongs,
the identified product class specifying attributes shared by all products belonging to the identified product class;
creating a product definition having the attributes specified by the identified product class by instantiating an instance of the identified class;
identifying the created product definition in accordance with the received identifying information;
receiving indications of attributes possessed by the identified product not shared by all products belonging to the identified product class; and
adding to the created product definition the indicated attributes.

14. The method of claim 13, further comprising, for each specified attribute and each indicated attribute:
receiving an indication of possible values for the attribute; and
incorporating the indicated possible values for the attribute in the product definition.

15. The method of claim 13, further comprising, before creating a product definition, determining that the identified product class exists.

16. The method of claim 13, further comprising, before creating a product definition, determining that all of the specified attributes exist.

17. A method in a computing system for transforming an initial definition for a distinguished configurable product, comprising:
retrieving the initial definition of the distinguished configurable product, in which each of a plurality of attributes of the distinguished configurable product are specified as a reference to a list of product options;
for each of the plurality of attributes of the distinguished configurable product specified in the initial definition as a reference to a list of product options, creating a definition of a new configurable product corresponding to the attribute and incorporating the list of product options;
creating a subsequent definition of the distinguished configurable product; and
for each created new configurable product, establishing a relationship between the created new configurable product and the created subsequent definition of the distinguished configurable product.

18. A system for transforming an initial definition for a distinguished configurable product, comprising:
a retrieval subsystem that retrieves the initial definition of the distinguished configurable product, in which each of a plurality of attributes of the distinguished configurable product are specified as a reference to a list of product options;
a configurable product creation subsystem that creates:
for each of the plurality of attributes of the distinguished configurable product specified in the initial definition as a reference to a list of product options, a definition of a new configurable product corresponding to the attribute and incorporating the list of product options, and
a subsequent definition of the distinguished configurable product; and
a relationship establishment subsystem that, for each created new configurable product, establishes a relationship between the created new configurable product and the created subsequent definition of the distinguished configurable product.
